(19) United States
(12) Patent Application Publication
(10) Pub. No.: US 2008/0300829 A1
(43) Pub. Date: Dec. 4, 2008

(54) Data collection apparatus

(75) Inventor: Jun Tsuzuki, Musashino-shi (JP)

Correspondence Address: Edwards Angell Palmer & Dodge LLP, P.O. Box 55874, Boston, MA, 02205, US

(73) Assignee: Yokogawa Electric Corporation, Tokyo (JP)

(21) Appl. No.: 12/154,168

(22) Filed: May 20, 2008

(30) Foreign Application Priority Data
May 31, 2007 (JP) 2007-144947

(51) Int. Cl. G06F 17/40

(52) U.S. Cl. 702/187; 368/10

(57) ABSTRACT

In a data collection apparatus, a calendar display section and a file integration display section are displayed on a display screen of a two-dimensional display, a cursor for specifying the check time period of measurement data is provided in the calendar display section, the sampling time period of measurement data is also displayed therein as a line segment, and file integration information in the check time period specified with the cursor is displayed in the file integration display section.

This application claims priority to Japanese Patent Application No. 2007-144947, filed May 31, 2007, in the Japanese Patent Office. The Japanese Patent Application No. 2007-144947 is incorporated by reference in its entirety.

### TECHNICAL FIELD

The present disclosure relates to a data collection apparatus and in particular to an improvement in display of measurement data.

### RELATED ART

A paperless recorder as shown in patent document 1 for likening a two-dimensional display such as a liquid crystal display or a plasma display to record paper is available as a kind of data collection apparatus. The paperless recorder is adapted to convert various physical quantities of temperature, pressure, flow quantity, etc., into electric signals with sensors fitted to measurement targets, store the electric signals in data memory as measurement data, and display the change state of the provided electric signals with the passage of measurement time on a two-dimensional display as graph waveforms according to continuous line segments of channels.

Specifically, measurement signals in measurement channels are digitized in sampling period TS, for example, for storage in memory, the measurement data stored in the memory is read in sequence in display period TD (>TS) for each measurement channel, and the maximum value and the minimum value of the measurement data in the display period TD are displayed as a graph on a two-dimensional display as line segments for each measurement channel.

FIG. 3 is a drawing of a display screen example in such a paperless recorder in the related art. In FIG. 3, continuous line segments L1 to L6 represent the change states from comparatively low speed to comparatively high speed, of measurement signals of channels CH1 to CH6 as graph waveforms in predetermined assigned display colors. The time axis of the display screen in the measurement state scrolls from the right to the left as indicated by the arrow A′.

Pointers P1 to P6 indicate the current values of the measurement signals of the channels CH1 to CH6. They are in the same colors as the display colors of the measurement signal waveforms of the channels CH1 to CH6 and are given assigned channel numbers. The pointers P1 to P6 move in an amplitude Y axis direction (vertical direction) in association with change in the measurement values on the screen.

Scales SL1 to SL6 indicate scale values corresponding to the measurement ranges 0% to 100% of the measurement signals of the channels CH1 to CH6 together with physical quantity units and are assigned the same colors as the display colors of the measurement signal waveforms of the channels CH1 to CH6.

[Patent document 1] Japanese Patent Application Publication No. 2001-21385

By the way, in such a data collection apparatus, focusing attention on measurement data files relevant to the display screen in FIG. 3, for example, the display period responsive to the measurement application is set in a wide range from 1 min/div (shortest) to 4 H/div (longest), and measurement data is displayed on the display screen.

Summaries of the measurement data files are listed in file units from measurement start time START 1 to measurement end time END 2 together with the number of data pieces 3 between START 1 and END 2 as shown in FIG. 4, for example, as required.

To check the waveform, alarm information, etc., in the measurement data file, the user moves a cursor 4 to any desired measurement data file position by operating up and down cursor keys provided on an operation panel and opens the measurement data file. Then, the waveform, alarm information, etc., in the selected measurement data file is displayed on the display screen.

However, the display of the measurement data files in the related art is hard to be intuitive to understand information as to when the measurement data was sampled, when a time period over which measurement data is not sampled is, etc., and does not enable the user to immediately see whether or not an alarm occurred on a day-to-day basis, on a week-to-week basis, on a month-to-month basis, etc.; this is a problem.

Further, in a data collection apparatus of a recorder, etc., measurement data sampling is often performed over a long period of one week, one month, etc., as well as one day, and it is also desired that integrated information on a week-to-week or month-to-month basis concerning measurement data sampling should be able to be provided.

Japanese Patent Application Publication No. 2000-308005 discloses display of a thumbnail of stored image data in a cell for each day of a one-month calendar screen, but does not disclose display of integrated information on a week-to-week or month-to-month basis.

Japanese Patent Application Publication No. 2006-135430 discloses an art of providing an area for displaying an image for each week together with a one-month calendar screen, but does not disclose display of integrated information on a week-to-week or month-to-month basis either.

### SUMMARY

Exemplary embodiments of the present invention provide a data collection apparatus that can display integration information of sampling of measurement data on a day-to-day basis, on a week-to-week basis, or on a month-to-month basis and enables the user to intuitively keep track of the measurement data sampling state and alarm information.

To the end, according to a first invention, there is provided a data collection apparatus having a two-dimensional display which displays a calendar display section and a file integration display section on a display screen, wherein a cursor for specifying the check time period of measurement data is provided in the calendar display section and the sampling time period of measurement data is also displayed therein as a line segment, and wherein file integration information in the check time period specified with the cursor is displayed in the file integration display section.

A second invention is characterized by the fact that in the data collection apparatus according to the first invention, the calendar display section is provided with a selection display area for selecting and specifying a display target in the sampling time period of measurement data.

A third invention is characterized by the fact that in the data collection apparatus according to the first or second invention, the file integration information contains at least any of the type of sampled measurement data file, the presence or absence of alarm occurrence, or the presence or absence of message information.

A fourth invention is characterized by the fact that in the data collection apparatus according to any of the first to third aspects, an alarm mark is displayed at the position of the alarm occurrence time on the line segment displaying the sampling time period of the measurement data.

A fifth invention is characterized by the fact that in the data collection apparatus according to any of the first to fourth aspects, vertical positions of the line segments displaying the sampling time periods of the measurement data are associated with the measurement data pieces.

According to a sixth invention, there is provided a data collection apparatus including a two-dimensional display which displays a calendar display section and a file integration display section on a display screen; a measurement data file storage section for storing a measurement data file; a cursor operation section for moving a cursor in the cursor movable range of the calendar display section; a cursor position identification section for identifying the position of the cursor in the cursor movable range of the calendar display section; a display target selection specification section for selecting and specifying the display target to be displayed in the calendar display section and the file integration display section; a measurement data file read section for reading the corresponding measurement data file from the measurement data file storage section based on the identification result of the cursor position identification section and the selection specification information of the display target selection specification section; a calendar display generation section for generating a predetermined calendar screen based on the selection specification information of the display target selection specification section and the measurement data file read from the measurement data file storage section; and a file integration display generation section for generating a predetermined file integration display screen based on the selection specification information of the display target selection specification section and the measurement data file read from the measurement data file storage section.

Thus, a data collection apparatus that can display integration information of sampling of measurement data on a day-to-day basis, on a week-to-week basis, or on a month-to-month basis and enables the user to intuitively keep track of the measurement data sampling state and alarm information can be provided.

Other features and advantages may be apparent from the following detailed description, the accompanying drawings and the claims.

### BRIEF DESCRIPTION OF THE DRAWINGS

In the accompanying drawings:

FIG. 1 is a drawing of a display screen example based on the invention;

FIG. 2 is a specific block diagram to display a display screen as shown in FIG. 1;

FIG. 3 is a drawing of a display screen example in a paperless recorder in a related art; and

FIG. 4 is a drawing of a display example of measurement data files in a related art.

### DETAILED DESCRIPTION

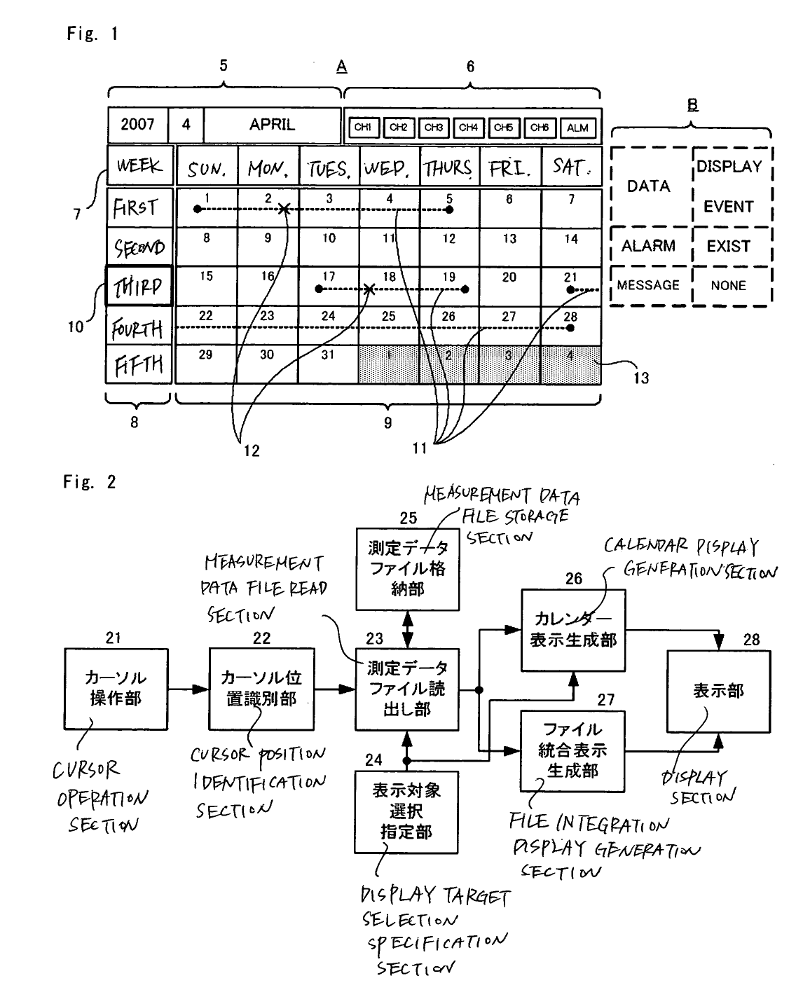

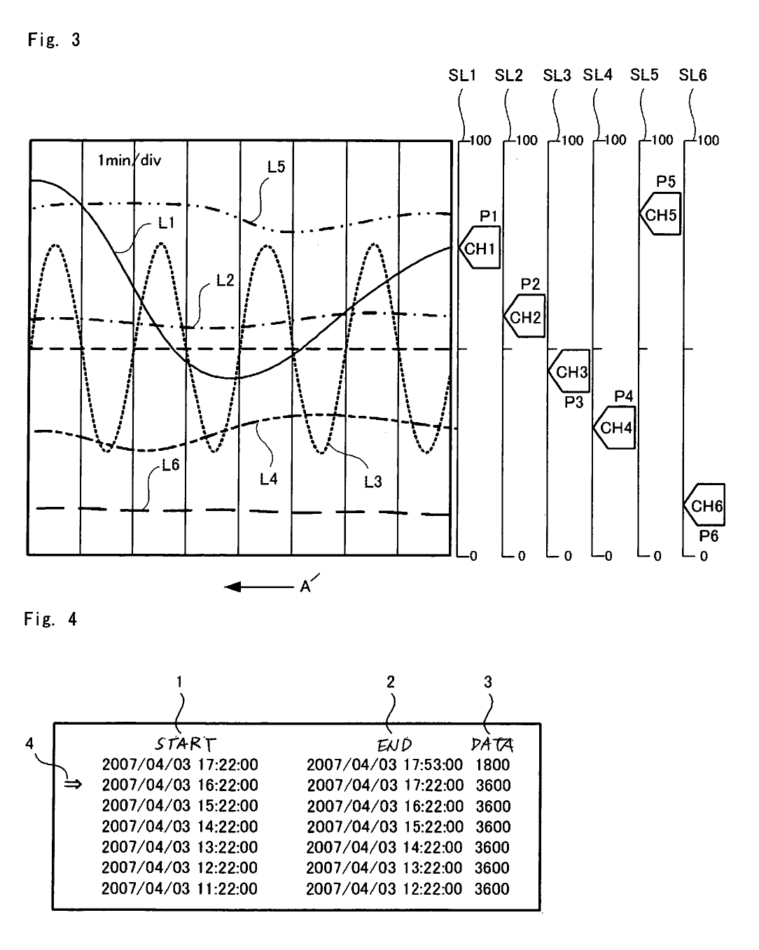

The invention will be discussed with reference to the accompanying drawings. FIG. 1 is a drawing of a display screen example based on the invention. In FIG. 1, the display screen is made up of a calendar display section A and a file integration display section B.

A year and month display area 5 and a selection display area 6 are provided at the top of the calendar display section A.

In an embodiment of the invention, a year display part “2007” and a digital month display part “4” and an English month display part “APRIL” are displayed in the year and month display area 5.

The selection display area 6 is an area for displaying the display target selected and specified in a display target selection specification section 24 shown in FIG. 2; in the embodiment, measurement channels CH1 to CH6 and alarm ALM are selectively displayed.

A week and day of week display area 7 is provided below the year and month display area 5 and the selection display area 6, a week display area 8 is provided below the week display part, and a day display area 9 is provided below the day of week display part.

A cursor 10 selects and specifies the third week in the embodiment and a sampling line 11 indicates the time zone in which sampling was performed. An alarm mark 12 indicates the time at which an alarm occurred during the sampling. A shaded portion 13 indicates days of the next month. The cursor 10 is masked so that it cannot move to the year display part “2007” or the English month display part “APRIL” of the year and month display area 5 or the week and day of week display area 7.

The cursor 10 is moved to and stopped at any desired unmasked and movable position, whereby integrated information in the measurement data file in the corresponding predetermined time period units on the calendar is displayed in the file integration display section B. That is, when the cursor 10 stops anywhere in the day display area 9, the integrated information on a day-to-day basis is displayed; when the cursor 10 stops anywhere in the week display area 8, the integrated information on a week-to-week basis is displayed; and when the cursor 10 stops at the digital month in the year and month display area 5, the integrated information on a month-to-month basis is displayed.

In the file integration display section B, “DATA” represents the type of sampled measurement data file; “DISPLAY” means that display data exists, “EVENT” means that event data exists, and “NONE” means that no data exists.

“ALARM” represents occurrence of an alarm; “EXIST” means that alarm information exists and “NONE” means that no alarm information exists.

“MESSAGE” indicates whether or not a message has been input; “EXIST” means that message information exists and “NONE” means that no message information exists.

FIG. 2 is a specific block diagram to display a display screen as shown in FIG. 1. A cursor operation section 21 is operated, whereby the cursor 10 can be moved in the unmasked cursor movable range of the calendar display section A.

A cursor position identification section 22 identifies the position of the cursor 10 in the cursor movable range of the calendar display section A and inputs the identification result as to which of the day display area 9, the week display area 8, and the digital month in the year and month display area 5 the cursor is in to a measurement data file read section 23.

The display target selection specification section 24 is for the user to select and specify any of the measurement channels CH1 to CH6 or the alarm ALM displayed in the selection display area 6. Selection specification information is input to the measurement data file read section 23 and a calendar display generation section 26.

The measurement data file read section 23 reads the corresponding measurement data file from a measurement data file storage section 25 based on the identification result of the cursor position identification section 22 and the selection specification information of the display target selection specification section 24 and inputs the measurement data file to the calendar display generation section 26 and a file integration display generation section 27.

The calendar display generation section 26 generates an image to display the measurement channels CH1 to CH6 and the alarm ALM selectively specified in the selection display area 6 at high brightness, for example, based on the selection specification information of the display target selection specification section 24, generates an image so as to display the line segment 11 as a sampling line corresponding to the sampling time period of the measurement data read from the measurement data file storage section 25 based on the selectively specified measurement channel CH1 to CH6 information, and further generates an image so as to display the alarm mark 12 at the position of the time on the line segment 11 corresponding to the sampling time period of the measurement data based on the alarm ALM information.

The vertical positions of the line segments 11 displayed in the cells in the day display area 9 of the calendar display section A are associated with the measurement channels CH1 to CH6, whereby the sampling time period of the measurement data for each measurement channel can be displayed.

The display colors of the line segments 11 are made the same as the colors assigned to the measurement channels, whereby intuitive discrimination can be further enhanced.

The file integration display generation section 27 generates an image to display the file integration display section B of the measurement data as shown in FIG. 1 on a day-to-day basis, on a week-to-week basis, or on a month-to-month basis based on the selection specification information of the display target selection specification section 24 and the measurement data file read from the measurement data file storage section 25.

In so doing, a display screen as shown in FIG. 1 is displayed on a display section 28. The line segments 11 corresponding to the sampling time periods of the measurement data of the measurement channels CH1 to CH6 selectively specified are displayed on the calendar display section A, thereby enabling the user to intuitively recognize the sampling time period over which measurement data sampling was performed.

Since the file integration display section B is provided adjacent to the calendar display section A, the user can precisely keep track of a summary of file integration information on a day-to-day basis, on a week-to-week basis, or on a month-to-month basis according to the displayed words simply by placing the cursor at the position of the time period to be checked.

An alarm mark is put on the position of the alarm occurrence time on the line segment 11 corresponding to the sampling time period of the measurement data of the measurement channel CH1 to CH6 selectively specified, displayed on the calendar display section A, thereby enabling the user to intuitively know when the alarm occurred.

If the display screen is large, the line segment representing the sampling time period of the measurement data may be an actual measurement data waveform rather than a straight line.

For example, a waveform display button may be provided and if the waveform display button is pressed, a measurement data waveform associated with the file integration information on a day-to-day basis, on a week-to-week basis, or on a month-to-month basis displayed in the file integration display generation section 27 may be able to be displayed temporarily in the calendar display section A.

In the embodiment, the paperless recorder for measuring and recording various physical quantities of temperature, pressure, flow quantity, etc., as measurement data has been described by way of example, but the invention is not limited to it. For example, the body weight, the body fat ratio, various kinds of training data, etc., can also be utilized for health care as measurement data.

As described above, according to the invention, a data collection apparatus that can display integration information of sampling of measurement data on a day-to-day basis, on a week-to-week basis, or on a month-to-month basis and enables the user to intuitively keep track of the measurement data sampling state and alarm information can be provided, and is suited for measurements in various fields.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A data collection apparatus comprising:
a two-dimensional display which displays a calendar display section and a file integration display section on a display screen,
wherein a cursor for specifying a check time period of measurement data is provided in the calendar display section and a sampling time period of measurement data is also displayed in the calendar display section as a line segment, and
wherein file integration information in the check time period specified with the cursor is displayed in the file integration display section.

2. The data collection apparatus as claimed in claim 1 wherein the calendar display section is provided with a selection display area for selecting and specifying a display target in the sampling time period of measurement data.

3. The data collection apparatus as claimed in claim 1 wherein the file integration information contains at least any of the type of sampled measurement data file, the presence or absence of alarm occurrence, or the presence or absence of message information.

4. The data collection apparatus as claimed in claim 1 wherein an alarm mark is displayed at a position of an alarm occurrence time on the line segment displaying the sampling time period of the measurement data.

5. The data collection apparatus as claimed in claim 1 wherein vertical positions of the line segments displaying the sampling time periods of the measurement data are associated with the measurement data pieces.

6. A data collection apparatus comprising:
a two-dimensional display which displays a calendar display section and a file integration display section on a display screen;
a measurement data file storage section which stores a measurement data file;
a cursor operation section which moves a cursor in a cursor movable range of the calendar display section;
a cursor position identification section which identifies a position of the cursor in the cursor movable range of the calendar display section;
a display target selection specification section which selects and specifies a display target to be displayed in the calendar display section and the file integration display section;
a measurement data file read section which reads the corresponding measurement data file from said measurement data file storage section based on an identification result of said cursor position identification section and a selection specification information of said display target selection specification section;
a calendar display generation section which generates a predetermined calendar screen based on the selection specification information of said display target selection specification section and the measurement data file read from said measurement data file storage section; and
a file integration display generation section which generates a predetermined file integration display screen based on the selection specification information of said display target selection specification section and the measurement data file read from said measurement data file storage section.
